(19) United States
(12) Patent Application Publication
(10) Pub. No.: US 2005/0042063 A1
(43) Pub. Date: Feb. 24, 2005

(54) Storage and retrieval unit

(76) Inventor: Franz Ehrenleitner, Altensteig-Walddorf (DE)

Correspondence Address: King & Jovanovic, PLC, 170 College Avenue, SUITE 230, HOLLAND, MI, 49423, US

(21) Appl. No.: 10/728,729

(22) Filed: Dec. 5, 2003

(30) Foreign Application Priority Data
Dec. 5, 2002 (DE) 102 57 109.0

(51) Int. Cl. B65G 1/00

(52) U.S. Cl. 414/266

(57) ABSTRACT

A storage and retrieval unit comprises in a known manner a supporting carriage which is movable along a rack aisle on at least one substantially horizontal supporting rail. A lifting platform intended for receiving storage items is taken along by the supporting carriage in the horizontal movement and can be moved relative to it in the vertical direction with the aid of a lifting apparatus comprising at least two traction means on which the lifting platform is suspended. In order to prevent the lifting platform from swinging out in the lateral direction, a stabilising device is provided. The latter comprises a stabilising carriage which is movable by means of its own drive along at least one guide rail running at a vertical distance from and parallel to the supporting rail. A substantially rigid connecting structure having a horizontal extension component is articulated both on the lifting platform and on the stabilising carriage. The horizontal distance between the lifting platform and the stabilising carriage is changed by means of a control system, by corresponding movement of the stabilising carriage, in such a way that the lifting platform can perform only the desired, in particular vertical, movement relative to the supporting carriage. This storage and retrieval unit has only very small masses which can oscillate and are to be accelerated.

### BACKGROUND OF THE INVENTION

1. Field of the Invention

The invention relates to a storage and retrieval unit having (a) a supporting carriage which is movable along a rack aisle on at least one substantially horizontal supporting rail by means of a drive; (b) a lifting platform carried along by the supporting carriage and intended for receiving storage items; (c) a lifting apparatus by means of which the lifting platform is movable in the vertical direction relative to the supporting carriage; (d) a stabilising device which prevents lateral deflection of the lifting platform relative to the supporting carriage.

2. Background Art

Storage and retrieval units of this type serve to store storage items in the compartments of high-bay racks and remove them from these again. The high-bay racks extend along a rack aisle in which the storage and retrieval unit is movable. To achieve a high turnover of the storage items and hence to minimise the overall size of the high-bay warehouse required for a given capacity, the speed with which the lifting platform can be moved from one position to the other should be as great as possible. Since the accelerated mass and the connecting device via which the lifting platform is connected to the supporting carriage form an oscillating system, a high acceleration usually also means the risk of large oscillations of the lifting platform.

Known storage and retrieval units of the type mentioned at the outset therefore have, besides the supporting carriage which is generally movable on the room floor, a massive column which is used to stabilise the lifting platform and on which the lifting platform is guided during its vertical movement. In order to achieve the necessary stiffness of the guide column, large masses are required. Storage and retrieval units of this type can reach a total weight of 25 metric tons. It is clear that enormous driving powers are required to be able to operate these storage and retrieval units with high accelerations. Despite the massive guide columns, considerable oscillation problems arise, especially as the natural frequencies of the oscillating system are relatively low on account of the high masses.

The object of the present invention is to design a storage and retrieval unit of the type mentioned at the outset in such a way that the lifting platform can be accelerated very rapidly and oscillation problems are minimised.

### SUMMARY OF THE INVENTION

This object is achieved according to the invention in that (e) the lifting apparatus comprises at least two traction means, on which the lifting platform is suspended from the supporting carriage; (f) the stabilising device comprises: (fa) a stabilising carriage which is movable by means of its own drive along at least one guide rail running at a vertical distance from and parallel to the supporting rail; (fb) a substantially rigid connecting structure having a horizontal extension component and articulated both on the lifting platform and on the stabilising carriage; (fc) a control system which, in the event of a change in the vertical position of the lifting platform, changes the horizontal distance between the lifting platform and the stabilising carriage, by corresponding movement of the stabilising carriage, in such a way that the lifting platform can perform only the desired, in particular vertical, movements relative to the supporting carriage.

The term “traction means” is understood to mean primarily ropes, chains, belts or the like. For terminological simplification these are referred to below as “ropes”, which are representative of traction means of these types.

The basic idea behind the invention is to ensure the least possible mass for all the accelerated parts of the storage and retrieval unit. This has the result that, on the one hand, the forces required for acceleration and hence also the power to be produced by the drives can be low. On the other hand, the resonant frequencies are shifted to a higher frequency range, where they can be managed more easily. Savings of mass are achieved in the present invention both in the design of the lifting apparatus and of the stabilising device. The lifting apparatus comprises, according to the invention, at least three ropes, thus no rigid components, and therefore achieves the minimum mass possible. The stabilising device does without massive, heavy elements and relies instead on an easily constructible connecting structure by which the lifting platform is, so to speak, always held from the side in such a way that it can move only in the desired fashion, generally vertically, relative to the supporting carriage. The connecting structure is supported on the stabilising carriage additionally provided according to the invention. Since the angle assumed by the connecting structure with respect to the horizontal is changed during a vertical movement of the lifting platform, the horizontal distance between the stabilising carriage and the lifting platform must be changed in proportion to the cosine of this angle of inclination. This is done with the aid of a control system which is supplied, for this purpose, with a signal representative of the vertical position of the lifting platform. During a simultaneous horizontal movement of the supporting carriage and vertical movement of the lifting platform, the stabilising carriage is controlled in such a way that the change in distance required to maintain the desired movement, in particular an exact vertical movement, of the lifting platform relative to the supporting carriage is superimposed on a horizontal movement speed corresponding to that of the supporting carriage.

The storage and retrieval unit according to the invention is a kinematically unambiguously defined system whose sequences of movements can be readily calculated by computer without ambiguous solutions arising.

Preferably, the connecting structure comprises two parallel bars. These bars are only subjected to compression or tension, and can thus be kept relatively thin. As a result, that mass which is to be accelerated during the movement of the lifting platform is again reduced.

The bars are preferably stiffened by braces to form a framework. Since the connecting structure essentially forms the spring of the oscillating system, this stiffening leads to a desired shifting of the resonant frequency of the oscillating system to higher values.

In order to be able to reach the entire rack with the storage and retrieval unit according to the invention, the guide rail on which the stabilising carriage moves can be extended beyond the rack at one end. An alternative to this is for the “effective length” of the connecting structure to be capable of being shortened. Normally, the supporting carriage cannot be moved past the stabilising carriage in the horizontal direction, since the length of the connecting structure is necessarily greater than the vertical distance between the supporting rail and the guide rail. If, however, the effective length of the connecting structure can be shortened, the supporting carriage can move past the stabilising carriage in the horizontal direction and then resume its normal storage and retrieval operation on the other side of the stabilising carriage.

The “effective length” of the connecting structure can be shortened, for example, in that at least one swivel arm, which is swivellably connected to one end of the connecting structure, is articulated on the stabilising carriage and is lockable to it in at least one angular position. With this design, the supporting carriage and the lifting platform carried along by the latter change the side of the stabilising carriage they are on in the following way: the stabilising carriage is stopped and the locking of the swivel arm to the stabilising carriage is released. Now, the supporting carriage can move towards the stabilising carriage in the horizontal direction. The “effective length” of the connecting structure is shortened by the swivel arm of the stabilising carriage being swung out downwards. After overcoming a “dead centre” at which both the swivel arm and the connecting structure are vertical, the swivel arm is brought up to the stabilising carriage again. When the supporting carriage has reached a sufficient distance from the stabilising carriage, the swivel arm is locked to the stabilising carriage again. Normal operation of the storage and retrieval unit can now be resumed.

At least one swivel arm, which is swivellably connected to the other end of the connecting structure, can also be articulated on the lifting platform and is lockable to it in an angular position. This additional swivel arm on the lifting platform gives the entire system an additional degree of freedom during the change of the supporting carriage and lifting platform from one side of the stabilising carriage to the other.

An alternative method of being able to shorten the “effective length” of the connecting structure consists in that it has elements which are telescopable with respect to one another and lockable in at least one relative position with respect to one another.

Since the stabilising function of the stabilising carriage is not provided during a change of sides of the supporting carriage and lifting platform, a refinement of the invention is advisable in which the lifting platform is lockable in its uppermost position to the supporting carriage. Before commencing a change of sides, the lifting platform is brought into this locked position so as thereby to prevent lateral oscillations of the lifting platform.

### BRIEF DESCRIPTION OF THE DRAWINGS

An exemplary embodiment of the invention is explained in more detail below with reference to the drawing, in which

FIG. 1 shows, in perspective, a storage and retrieval unit according to the invention in front of a high-bay rack;

FIG. 2 shows the side view relating to FIG. 1;

FIG. 3 shows the storage and retrieval unit of FIG. 1 in another position on the high-back rack;

FIG. 4 shows the side view relating to FIG. 3;

FIG. 5 shows the storage and retrieval unit of FIGS. 1 to 4 in a further position on the high-bay rack;

FIGS. 6 to 8 show, schematically, the sequence of movements during a change of sides of the supporting carriage, which is part of the storage and retrieval unit.

### DETAILED DESCRIPTION OF THE DRAWINGS

While this invention is susceptible of embodiment in many different forms, there is shown in the drawings and described herein in detail a specific embodiment with the understanding that the present disclosure is to be considered as an exemplification of the principles of the invention and is not intended to limit the invention to the embodiment illustrated.

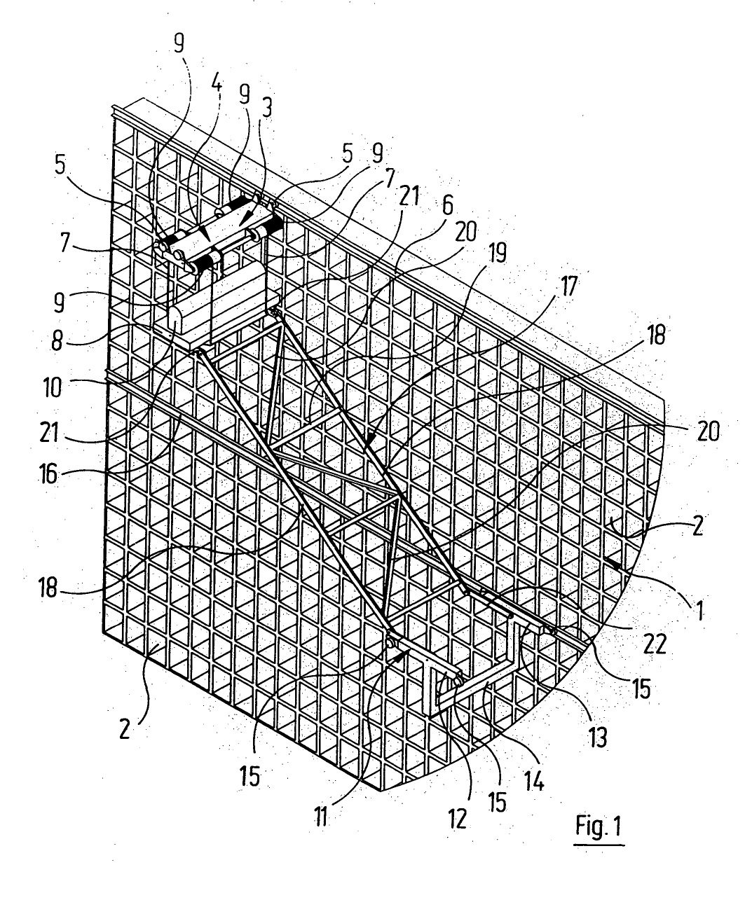

In FIG. 1, the reference numeral 1 denotes a conventional high-bay rack which comprises a steel structure and has in a known manner a multiplicity of rack compartments 2 in which storage items can be accommodated. The loading of the storage compartments 2 and the removal of storage items from these is handled by a storage and retrieval unit, which bears as a whole the reference numeral 3. The storage and retrieval unit 3 comprises a supporting carriage 4 having on opposite sides two supporting rollers 5 driven by a motor (not illustrated). The supporting-roller pair 5 situated in each case on one side of the supporting carriage 4 runs in a supporting rail 6 attached to the upper edge of the high-bay rack 1. Only one of the two supporting rails 6 and only one of the two high-bay racks 1 are illustrated in the drawing; the second high-bay rack can be imagined as being parallel to the one illustrated and such that the supporting rollers 5 of the supporting carriage 4 which are arranged on the left in the drawing engage in a corresponding supporting rail of the further high-bay rack 1. In this way, a rack aisle in which the storage and retrieval unit 3 moves is formed between the two high-bay racks 1.

The supporting carriage 4 of the storage and retrieval unit 3 is connected to a lifting platform 8 via four ropes 7. The supporting carriage 4 is provided with four rope drums 9 which are driven by motors (not illustrated) and on which the upper end regions of the ropes 7 can be wound up. By actuating the rope drums 7 in the corresponding direction of rotation, the lifting platform 8 can be lowered or lifted in the known manner.

The lifting platform 8 supports the storage items 10, which, on correct positioning of the lifting platform 8 in front of the desired storage compartment 2, can be pushed into the storage compartment 2 by means of a known displacement device (not illustrated in the drawing). In a corresponding manner, storage items situated in a storage compartment 2 can be transferred onto the lifting platform 8 by this displacement device.

In order to stabilise the lifting platform 8 against lateral oscillation, the storage and retrieval unit 3 has a stabilising carriage 11. The stabilising carriage 11 comprises two longitudinal members 12, 13 connected to each other by a U-profile 14. On the two longitudinal members 12, 13 there are provided in each case two drive rollers 15 driven by motors (not illustrated). The drive rollers 15 assigned to the longitudinal member 13 run in a guide rail 16 which is likewise fastened to the high-bay rack 1, parallel to and below the supporting rail 6 of the supporting carriage 4. A corresponding guide rail is attached to the high-bay rack which is not illustrated in FIG. 1. The drive rollers 15 assigned to the longitudinal member 12 of the stabilising carriage 11 run in this guide rail.

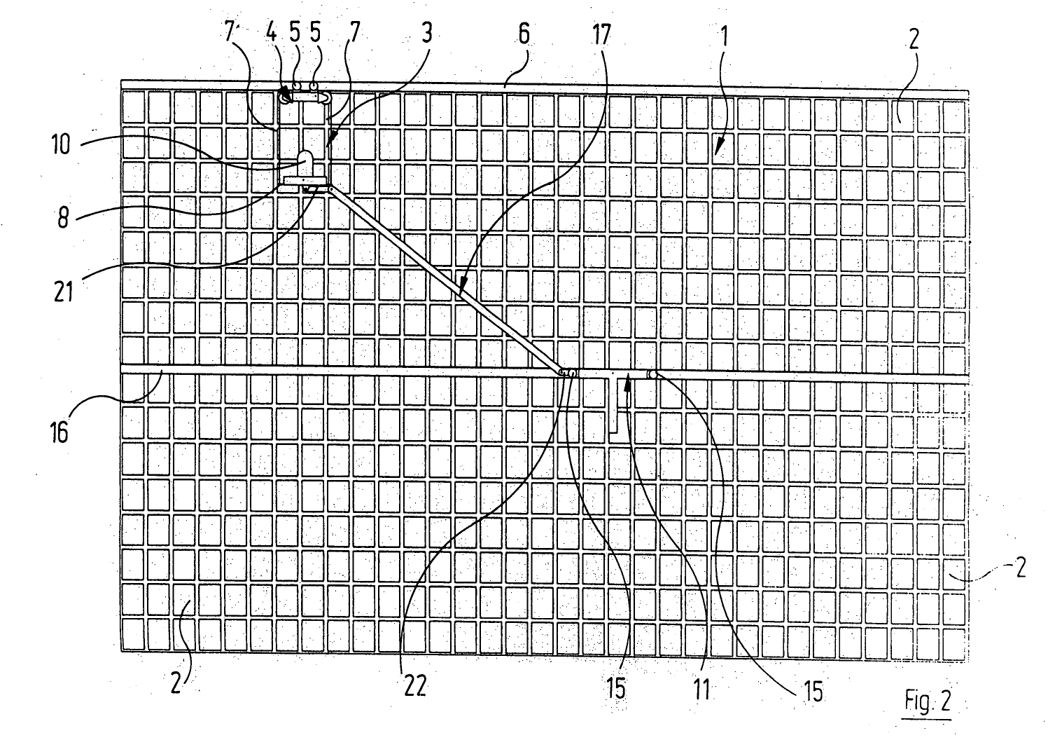

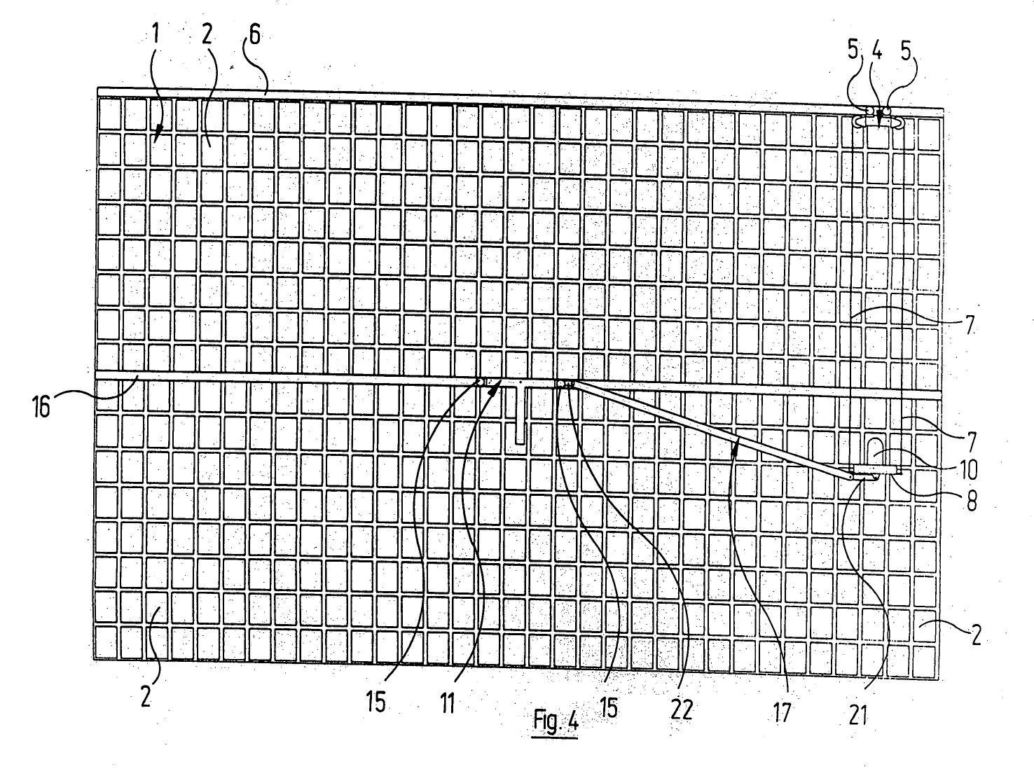

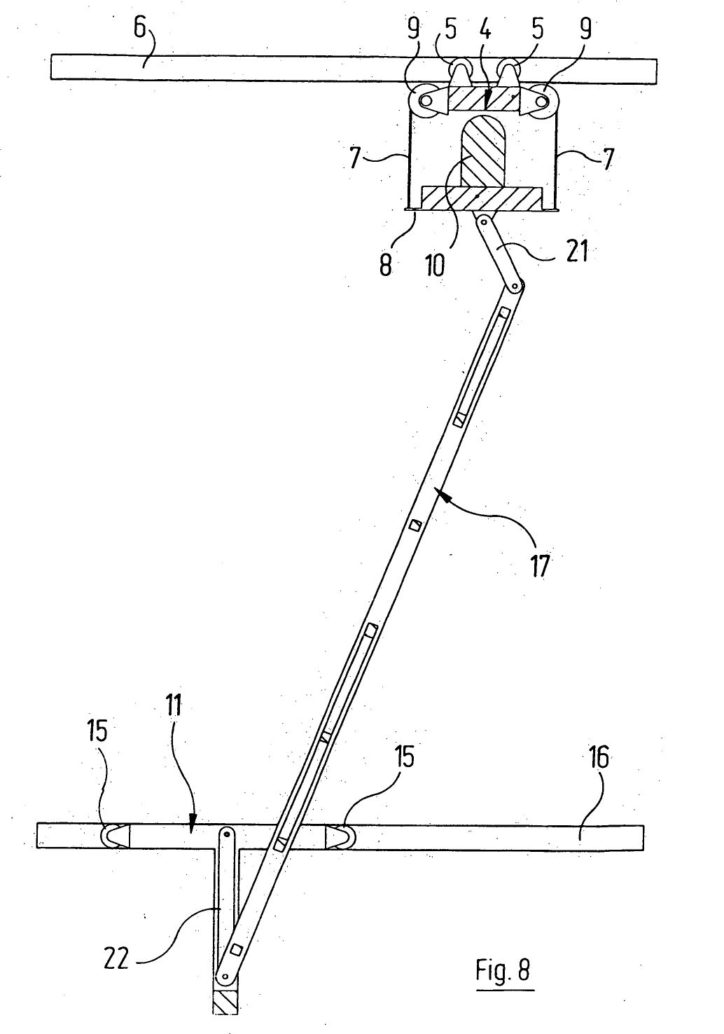

The lifting platform 8 of the storage and retrieval unit 3 is connected to the stabilising carriage 11 via a framework-like connecting structure, which bears as a whole the reference numeral 17. The connecting structure 17 has two parallel bars 18 connected to each other via stiffening braces 20 running perpendicularly thereto and diagonally. The upper ends of the two bars 18 of the connecting structure 17 are in each case articulatedly connected to one end of a swivel arm 21, the other end of which is articulated on the underside of the lifting platform 8. The swivel arm 21 can be seen particularly clearly in FIGS. 2, 4 and 6 to 8. The swivel arm 21 can be locked in the position illustrated in FIGS. 1 and 2.

The lower ends of the bars 18 of the connecting structure 17 are similarly articulatedly connected to one end of a swivel arm 22, the other end of which is articulated in each case approximately in the middle of the assigned longitudinal member 12, 13 of the stabilising carriage 11. These swivel arms 22 can also be seen particularly in FIGS. 2, 4 and 6 to 8. The swivel arms 22 can be locked to the longitudinal members 12, 13 in the position illustrated in FIGS. 1 and 2, and also in a position rotated through 180° relative to this.

The horizontal position of the supporting carriage 4 along the supporting rail 6 can be determined by a suitable position-measuring system. In a corresponding manner, the horizontal position of the stabilising carriage 11 is monitored by a suitable position-measuring system. A height-measuring system, finally, delivers information about the current vertical position of the lifting platform 8. The output signals of the two position-measuring systems of the supporting carriage 4 and of the stabilising carriage 11, and of the height-measuring system of the lifting platform 8, are supplied to a control system.

The above-described storage and retrieval unit 3 works as follows:

In FIG. 1, the lifting platform 8 is illustrated in a position in the left, upper region of the high-bay rack 1. Now, let us assume that the lifting platform 8 is to be lowered vertically downwards from this position. The desired destination position is input by a corresponding control signal into the control system. This control system now sets the rope drums 9 of the supporting carriage 4 in motion in such a way that the lifting platform 8 descends. At the same time, the control system gives the stabilising carriage 11 the command to move to the right in FIG. 1. The movement takes place here in such a way as to enable the desired vertical travel of the lifting platform 8, i.e. the horizontal distance of the stabilising carriage 11 from the supporting carriage and hence from the lifting platform 8 is changed in proportion to the cosine of the angle of inclination assumed by the connecting structure 17 relative to the horizontal. The distance between the stabilising carriage 11 and the lifting platform 8 is thus at a maximum and equal to the length of the connecting structure 17 when the lifting platform 8 is at the height of the guide rail 16 and the connecting structure 17 is horizontally oriented.

During the vertical movement of the lifting platform 8 described, the connecting structure 17 reliably prevents any oscillations, since forces acting in the lateral direction are transmitted via the connecting structure 17 to the stabilising carriage 11 and from the latter to the two high-bay racks 1.

If the lifting platform 8 is to be moved horizontally to the right from the position illustrated in FIG. 1 while retaining its vertical position, corresponding control signals are input into the control system. This control system now ensures that the translatory movement of the supporting carriage 4 takes place synchronously and at the same speed in relation to the translatory movement of the stabilising carriage 11, so that the geometric relative relationship between the supporting carriage 4, the connecting structure 17 and the stabilising carriage 11 thus remains unchanged as they travel together in the horizontal direction.

In general, of course, horizontal and vertical movements of the lifting platform 8 are superimposed, a task which can be managed without any problems by the control system.

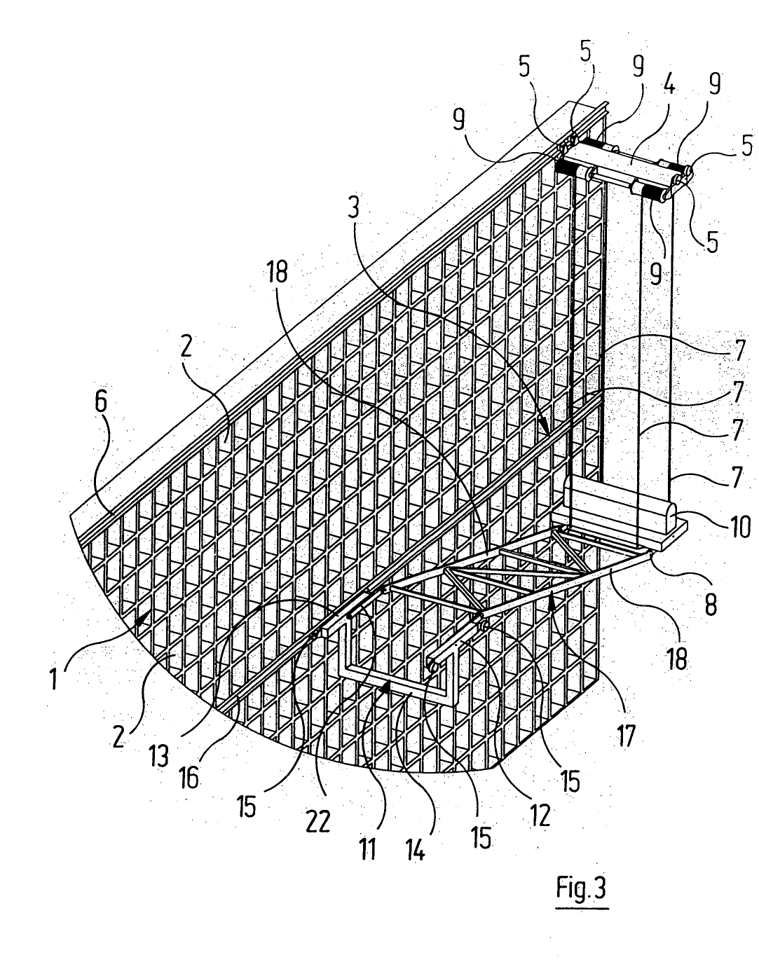

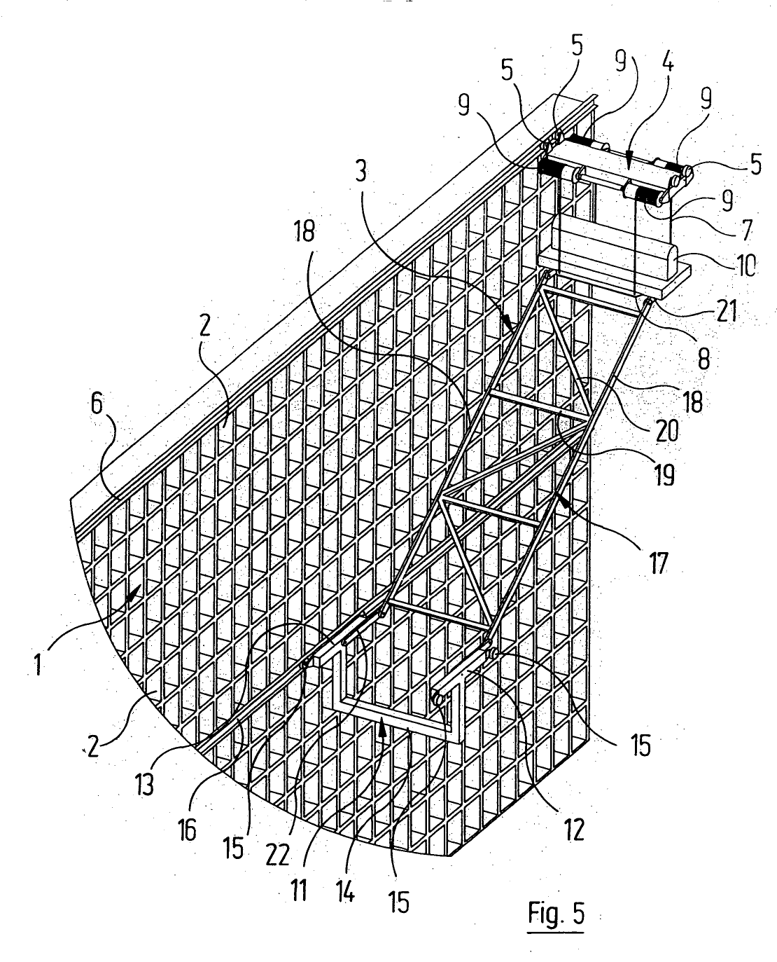

In order to be able to operate over the entire length of the high-bay racks 1 and nevertheless not have to move the stabilising carriage 11 beyond the high-bay racks 1 at one end thereof, it is possible for the supporting carriage 4 to change to the opposite side of the stabilising carriage 11. The way in which this is done is explained in detail hereinbelow. Such positions in which the supporting carriage 4 is situated on the other side of the stabilising carriage 11 are illustrated in FIGS. 3 and also 5 and 6. In FIG. 3, the lifting platform 8 is situated in the region of the right end of the high-bay rack 1, a little below halfway up, while in FIG. 5 the lifting platform 8 is lifted, in the same horizontal position, to be close to the upper edge of the high-bay rack 1.

In order to enable the change of the supporting carriage 4 to the other side of the stabilising carriage 11, for example in order to get from the position illustrated in FIG. 1 to the position illustrated in FIG. 5, the procedure is as follows:

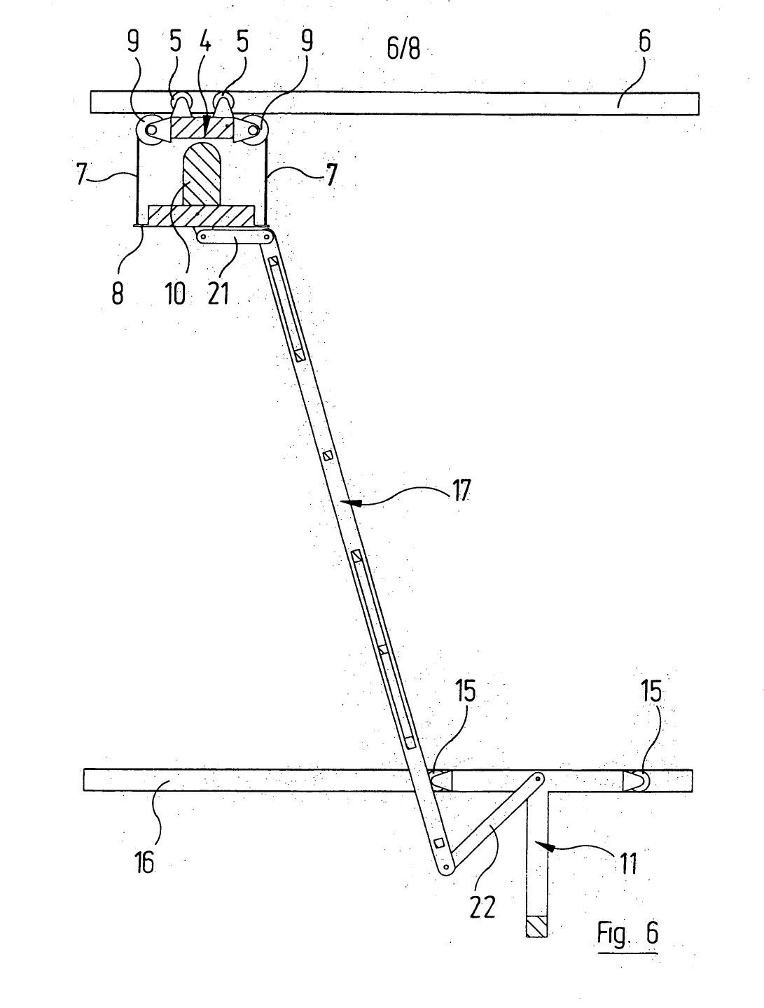

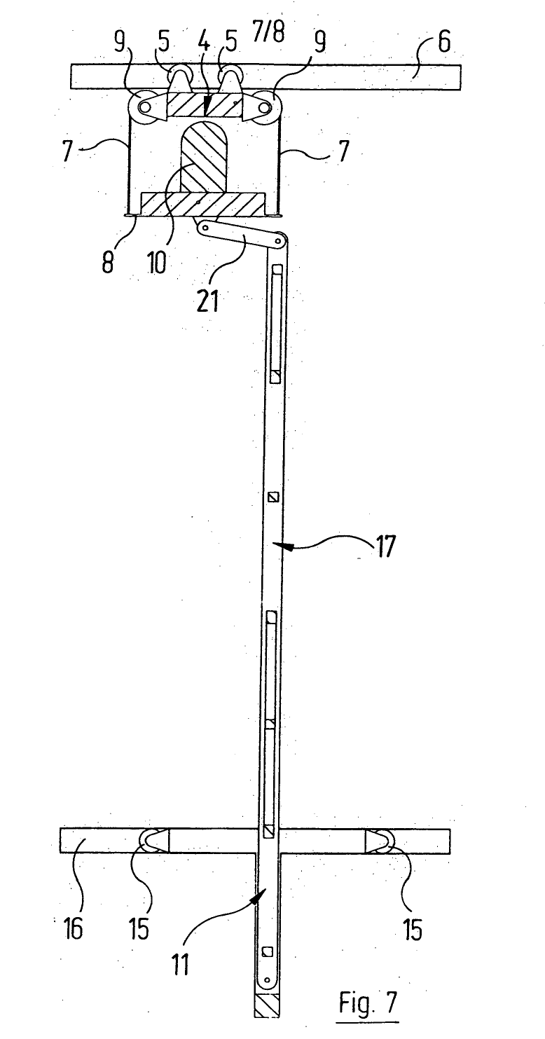

First of all, the lifting platform 8 is moved right up against the supporting carriage 4 and is locked to it, so that it can no longer oscillate freely in the ropes 7. Then, the swivel arms 21 of the lifting platform 8 and the swivel arms 22 of the stabilising carriage 11 are unlocked. The supporting carriage 4 is now moved towards the stationary stabilising carriage 11. This movement is made possible by the fact that the swivel arms 22 of the stabilising carriage 11 are swivelled downwards, as illustrated in FIG. 6. FIG. 7 shows the state in which the connecting structure 17 is vertical. In FIG. 7, it conceals the likewise vertical swivel arm 22. The swivel arm 21 of the lifting platform 8 has in this case swivelled a little away from its normal position. On continued travel of the supporting carriage 4 past the still stationary stabilising carriage 11, the connecting structure 17 now swivels in the opposite direction relative to the vertical; at the same time, the swivel angle of the swivel arm 21 assigned to the lifting platform 8 increases. If the supporting carriage 4 continues its movement in this direction, the swivel arms 22 are swivelled towards the stabilising carriage 11 again, until they have finally reached the horizontal orientation once again, where they have swivelled through 180 degrees relative to the starting position of FIG. 6. They are locked in this position again. In a corresponding manner, the swivel arms 21 of the lifting platform 8 also return to their horizontal position, where they have performed a swivelling movement of 180 degrees relative to their starting position of FIG. 6, and are locked in this position.

The storage and retrieval unit 3 can now operate on the opposite side of the stabilising carriage 11 in the manner already described above. For this to be possible, the locking of the lifting platform 8 to the supporting carriage 4 is released again.

In an exemplary embodiment which is not illustrated in the drawing, the stabilising carriage and/or the lifting platform do not have any swivel arms. In order nevertheless to enable a change of the supporting carriage 4 beyond the stabilising carriage 11, the connecting structure can be shortened by a telescope-like design. Normally, the telescopic members of the connecting structure are locked. This exemplary embodiment of the storage and retrieval unit then functions in the same way as described above with reference to FIGS. 1 to 5. To change the side of the supporting carriage, the telescoping facility of the connecting structure is freed. The connecting structure can thus be shortened as the supporting carriage approaches the stationary stabilising carriage, until it has reached the shortest length in its vertical orientation. After going beyond the “dead centre”, the telescopic parts of the connecting structure are then moved apart again and, on reaching their normal operating length, are locked. Normal operation of the storage and retrieval unit can then be resumed.

The foregoing description merely explains and illustrates the invention and the invention is not limited thereto except insofar as the appended claims are so limited, as those skilled in the art who have the disclosure before them will be able to make modifications without departing from the scope of the invention.

1. Storage and retrieval unit comprising:
a) a supporting carriage which is movable along a rack aisle on at least one substantially horizontal supporting rail by means of a drive;
b) a lifting platform carried along by the supporting carriage and intended for receiving storage items;
c) a lifting apparatus by means of which the lifting platform is movable in the vertical direction relative to the supporting carriage and comprises at least two traction means, on which the lifting platform is suspended from the supporting carriage;
d) a stabilising device which prevents lateral deflection of the lifting platform relative to the supporting carriage,
e) the stabilising device comprises:
ea) a stabilising carriage which is movable by means of its own drive along at least one guide rail running at a vertical distance from and parallel to the supporting rail;
eb) a substantially rigid connecting structure having a horizontal extension component and articulated both on the lifting platform and on the stabilising carriage;
ec) a control system which, in the event of a change in the vertical position of the lifting platform, changes the horizontal distance between the lifting platform and the stabilising carriage, by corresponding movement of the stabilising carriage, in such a way that the lifting platform can perform only the desired, in particular vertical, movement relative to the supporting carriage.

2. Storage and retrieval unit according to claim 1, wherein the connecting structure comprises two parallel bars.

3. Storage and retrieval unit according to claim 2, wherein the connecting structure is stiffened, by braces connecting the bars, to form a framework.

4. Storage and retrieval unit according to claim 1, wherein the effective length of the connecting structure can be shortened.

5. Storage and retrieval unit according to claim 4, further comprising at least one swivel arm, which is swivellably connected to one end of the connecting structure and is articulated on the stabilising carriage and is lockable to it in at least one angular position.

6. Storage and retrieval unit according to claim 5, wherein the at least one swivel arm, which is swivellably connected to the other end of the connecting structure, is articulated on the lifting platform and is lockable to it in at least one angular position.

7. Storage and retrieval unit according to claim 4, wherein the connecting structure has elements which are telescopable with respect to one another and lockable in at least one relative position with respect to one another.

8. Storage and retrieval unit according to claim 1, wherein the lifting platform is lockable in its uppermost position to the supporting carriage.
